(19) United States
(12) Patent Application Publication
(10) Pub. No.: US 2020/0116109 A1
(43) Pub. Date: Apr. 16, 2020

(54) FLOW RATE CONTROL VALVE

(71) Applicant: DENSO CORPORATION, Kariya-city (JP)

(72) Inventor: Yuichiro MIURA, Kariya-city (JP)

(21) Appl. No.: 16/591,790

(22) Filed: Oct. 3, 2019

(30) Foreign Application Priority Data
Oct. 15, 2018 (JP) 2018-194236

(51) Int. Cl. F02M 25/08; B60K 15/035; F16K 31/04

(52) U.S. Cl. CPC F02M 25/0836; B60K 2015/03256; F16K 31/04; B60K 15/03519

(57) ABSTRACT

A flow rate control valve includes a housing, a valve part, a driving part, a power transmission shaft and a sealing part. The valve part is provided in the housing. The driving part is placed outside the housing and configured to drive the valve part. The power transmission shaft penetrates the housing and connects the driving part to the valve part to enable power transmission. The sealing part seals a part through which the power transmission shaft penetrates and restrains a leakage of evaporated fuel from the housing. The sealing part includes a first sealing member and a second sealing member. The first sealing member is made of an organic material having a resistance against a fuel permeation, and the second sealing member is made of an organic material having a resistance against low temperature.

### CROSS REFERENCE TO RELATED APPLICATION

The present application claims the benefit of priority from Japanese Patent Application No. 2018-194236 filed on Oct. 15, 2018. The entire disclosure of the above application is incorporated herein by reference.

### TECHNICAL FIELD

The present disclosure relates to a flow rate control valve for an evaporated fuel treatment device.

### BACKGROUND

A known evaporated fuel treatment device recovers an evaporated fuel, referred to as a vapor hereinafter, of a fuel tank and enables to supply the vapor to an intake system of an internal combustion engine.

### SUMMARY

An evaporated fuel treatment device includes a fuel tank and a canister to adsorb evaporated fuel generated in the fuel tank. A control valve is provided to a vapor passage, which connects the canister to the fuel tank.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a structure of an evaporated fuel treatment device.

FIG. 2 is a schematic sectional view showing a flow rate control valve according to a first embodiment.

FIG. 3 is a schematic sectional view showing a sealing part.

FIG. 4 is a schematic sectional view showing the sealing part of the flow rate control valve according to a second embodiment.

FIG. 5 is a schematic sectional view showing the sealing part of the flow rate control valve according to a third embodiment.

FIG. 6 is a schematic sectional view showing the flow rate control valve according to a fourth embodiment.

### DETAILED DESCRIPTION

Hereinafter, one example of the present disclosure will be described.

According to the one example, an evaporated fuel treatment device includes a fuel tank, a canister, a flow rate control valve, and the like. The flow rate control valve is provided to a vapor passage connecting the fuel tank to the canister. The flow rate control valve performs operations such as to close the vapor passage while a vehicle stops and to open the vapor passage during fuel is fed to the vehicle.

In an assumable configuration, the flow rate control valve includes a housing including a discharge passage of the vapor, a valve which is housed in the housing, and a motor for driving. The motor is placed outside the housing. A shaft of the motor penetrates the housing and is connected to the valve. A shaft seal is provided outside the housing.

A structure and the material of the shaft seal may be important in order to restrain a leakage of evaporated fuel from a part at which the shaft penetrates the housing. For example, the shaft seal may be made of the fluororubber or the like which has a low permeability of the fuel in order to restrain the leakage of evaporated fuel to the outside of the shaft seal. However, a fluororubber generally has a specific characteristics at a low temperature and may become hard at the low temperature. Therefore, in this case, pressure leakage could occur. Some kinds of fluororubber have excellent characteristics at the low temperature, however, those are expensive.

On the other hand, the shaft seal may be made of a fluorosilicone rubber or the like in view of its characteristics at low temperature. However, in this case, the fluorosilicone rubber generally has high permeability of the fuel, and the evaporated fuel could pass to the outside of the shaft seal. That is, the shaft seal does not seal enough depending on the material or the structure of the shaft seal. Therefore, the evaporated fuel could be leaked to the outside from the part through which the shaft penetrates the housing.

According to an aspect of the present disclosure, a flow rate control valve for an evaporated fuel treatment device, which includes a fuel tank and a canister to adsorb evaporated fuel generated in the fuel tank, and is provided to a vapor passage connecting the canister to the fuel tank.

The flow rate control valve includes a housing, a valve part, a driving part, a power transmission shaft, and a sealing part. The housing includes a passage to allow the evaporated fuel to flow from a fuel tank side passage to a canister side passage. The valve part is provided in the housing and configured to shut off the fuel tank side passage from the canister side passage to restrict the evaporated fuel from flowing to the canister side passage and to communicate the fuel tank side passage to the canister side passage to pass the evaporated fuel to the canister side passage.

The driving part is placed outside the housing and configured to drive the valve part. The power transmission shaft penetrates the housing and connects the driving part to the valve part to enable power transmission. The sealing part seals a part at which the power transmission shaft penetrates and restrains a leakage of the evaporated fuel from the housing. The sealing part includes a first sealing member and a second sealing member. The first sealing member is made of a first organic material having a resistance against the fuel permeation. The second sealing member is made of a second organic material having a resistance against low temperature. The first organic material is different from the second organic material.

According to the aspect, the sealing part which seals the power transmission shaft penetrating the housing has a double sealing structure which includes the first sealing member and the seconds seal member. The first sealing member and the second sealing member have different characteristics, respectively. The first sealing member has the resistance against the fuel permeation, while the second sealing member has the resistance against low temperature. Therefore, the sealing part is configured to have contradicting properties. That is, the sealing part at which the power transmission shaft of the housing penetrates enables to provide higher sealing performance. This restrains the leakage of the evaporated fuel to the outside efficiently.

The flow rate control valve according to the aspect enables to restrain an evaporated fuel from reaching to the outside through the sealing part of the shaft penetrating the housing.

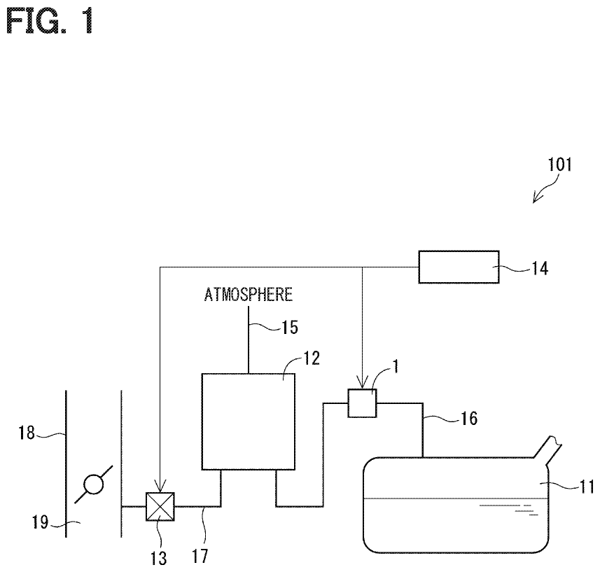

As follows, embodiments of the present disclosure will be described with reference to FIGS. 1 to 6.

### First Embodiment

[Structure]

A structure according to a first embodiment will be described with reference to FIGS. 1 to 3. As shown in FIG. 1, an evaporated fuel treatment device includes a flow rate control valve 1, a fuel tank 11, a canister 12, a purge valve 13, an ECU 14, and the like.

The fuel tank 11 is equipped in a vehicle and stores a fuel which is supplied to an internal combustion engine 18. The canister 12 includes an unillustrated adsorbent to collect evaporated fuel which is generated in the fuel tank 11. The canister 12 conducts a purge treatment. The canister 12 sends air which is taken in through an atmosphere passage 15 to an intake passage 19 of the internal combustion engine 18 with the evaporated fuel which flows through a vapor passage 16 and is adsorbed to the adsorbent of the canister 12. The vapor passage 16 connects the fuel tank 11 to the canister 12. The flow rate control valve 1 is equipped in the vapor passage 16. The purge valve 13 is also provided to a purge passage 17. Amount of the evaporated fuel which is purged and flows from the canister 12 to the intake passage 19 is controlled in accordance with the opening of the purge valve 13.

For example, in a state where the vehicle is parked, the flow rate control valve 1 keeps its closed state, and the evaporated fuel of the fuel tank 11 does not flow into the canister 12. On the other hand, for example, the flow rate control valve 1 keeps its opened state, while a tank cap of the fuel tank 11 is opened, and an oil supply is started to the fuel tank 11 until the oil supply is finished. Therefore, the evaporated fuel in the fuel tank 11 flows in the vapor passage 16 during an oil is supplied, and is adsorbed to the adsorbent in the canister 12. That is, the flow rate control valve 1 controls whether the fuel tank 11 communicates with the canister 12 or not. The ECU 14 is electrically connected to the flow rate control valve 1 and the purge valve 13, and controls an opening and closing operation of the flow rate control valve 1 and the purge valve 13.

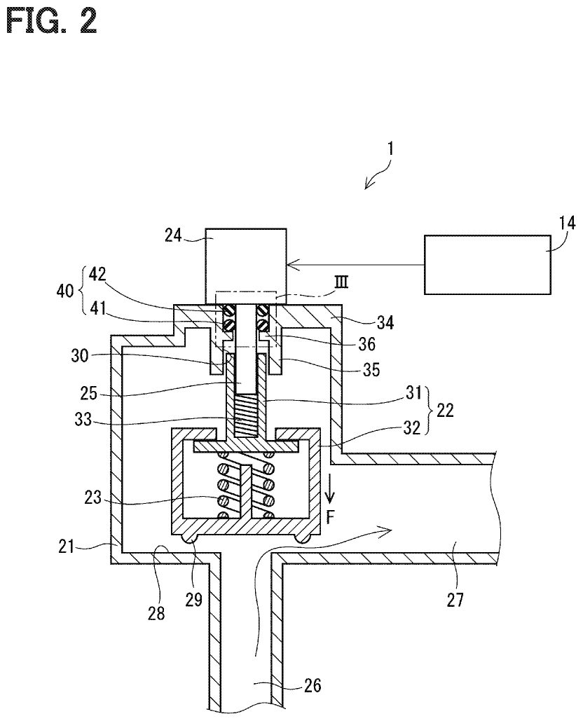

A structure of the flow rate control valve 1 will be described with reference to FIG. 2. A curved arrow in FIG. 2 shows an example of a movement pathway of the evaporated fuel. In FIG. 2, a sign F shows a direction in which a valve parts 22, which will be described below, moves to switch from the opened state to the closed state. The flow rate control valve 1 includes a housing 21, the valve part 22, a spring 23, a motor 24, a motor shaft 25, a sealing part 40, and the like. The housing 21 has a substantially cylindrical form and includes a pathway through which the evaporated fuel flows from a fuel tank side passage 26 to a canister side passage 27. A valve seat 28 is a flat plane of the housing 21 that extends from an edge of the fuel tank side passage in a direction orthogonal to the direction in which the valve part 22 moves.

The valve part 22 shuts off the fuel tank side passage 26 from the canister side passage 27 to restrict the evaporated fuel from flowing to the canister side passage 27, or allows to communicate the fuel tank side passage 26 to the canister side passage 27 to pass the evaporated fuel to the canister side passage 27.

The valve part 22 includes a small diameter cylindrical part 31 having a bottom and includes a large diameter cylindrical part 32 having a bottom. The small diameter cylindrical part 31 and the large diameter cylindrical part 32 have a common central axis. The small diameter cylindrical part 31 is integrally formed and is closer to the motor than the large diameter cylindrical part 32. The spring 23 is placed between the bottom of the small diameter cylindrical part 31 and the bottom of the large diameter cylindrical part 32. A rubber seal 29 is arranged in a circular shape at the bottom of the large diameter cylindrical part 32. FIG. 2 shows the flow rate control valve in the opened state when the valve part 22 is most separated from the valve seat 28.

Screw grooves 33 are formed on an inner peripheral surface of the small diameter cylindrical part 31. The motor shaft 25 is inserted in the small diameter cylindrical part 31. Screw threads which are formed on an outer peripheral surface of the motor shaft 25 are screwed and connected to the screw grooves 33 of the small diameter cylindrical part 31.

A rotation restriction projected part 35 protrudes from a bottom wall 34 of the housing 21 inward the housing 21. The rotation restriction projected part 35 has a cylindrical form and forms an insertion hole 30 of the motor shaft 25. A part of the small diameter cylindrical part 31 is inserted into the insertion hole 30 along a wall of the rotation restriction projected part 35 on a side of the valve part 22. A prescribed clearance is formed between an inner peripheral surface of the rotation restriction projected part 35 and an outer peripheral surface of the small diameter cylindrical part 31. The motor shaft 25 is inserted to the rotation restriction projected part 35 from the motor side. That is, the motor shaft 25 penetrates the housing 21. The motor shaft 25 connects the motor 24 to the valve part 22 such that transmission of rotational force of the motor 24 to the valve part 22 is enabled. The motor 24 corresponds to a driving part while the motor shaft 25 corresponds to a power transmission shaft.

The motor 24 is provided outside the housing 21 and connected to the bottom wall 34 of the housing 21. The motor shaft 25 rotates in a specific direction by driving the motor, and the valve part 22 moves in an opening direction, which is opposite to the direction indicated by the sign F, or in a closing direction which is indicated by the sign F. By the movement of the valve part 22 as described the above, the rubber seal 29 of the valve part 22 can be reciprocated so as to abut against the valve seat 28 or be separated from the valve seat 28.

A sealing part receiver 36 is formed in the rotation restriction projected part 35. The sealing part receiver 36 has a circular form and protrudes inward in a radial direction. The sealing part 40 is arranged between the motor 24 and the sealing part deceiver 36 and seals a part through which the motor shaft 25 penetrates such that the evaporated fuel is not leaked from the housing 21.

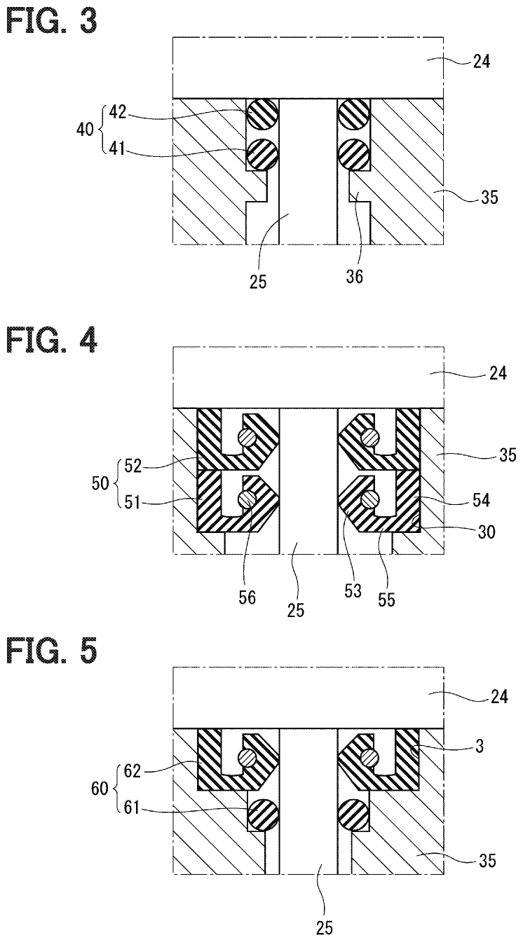

Detail of the sealing part 40 will be described as follows. As shown in FIGS. 2 and 3, the sealing part 40 includes a first sealing member 41 and a second sealing member 42. The first sealing member 41 is provided to the side of the valve part 22, while the second sealing member 42 is provided to a side of the motor 24. Each of the sealing members 41, 42 is inserted by pressing and adhered to the inner peripheral surface of the rotation restriction projected part 35. The first sealing member 41 abuts against the sealing part receiver 36. The first sealing member 41 is made of an organic material (first organic material) having a resistance against a fuel permeation. More specifically, a fluororubber (FKM) or a perfluoropolyether (FO) is applicable to the material.

The second sealing member 42 abuts against the bottom of the motor 24. The second sealing member 42 is made of an organic material (second organic material) having a resistance against low temperature. More specifically, an acrylonitrile-butadiene rubber (NBR), a hydrogenated nitrile rubber (HNBR), an epichlorohydrin rubber (ECO), or the like are applicable to the material. The first sealing member 41 and the second sealing member 42 are O-rings, respectively, and the material of the first sealing member 41 is different from that of the second sealing member 42. The first sealing member 41 has higher resistance against the fuel permeation than the second sealing member 42 does. The second sealing member 42 has higher resistance against low temperature than the first sealing member 41 does.

[Effect]

In the first embodiment described the above, the sealing members 41 and 42 are O-rings, which are made of different materials, and constitute a double seal structure. The first sealing member 41 and the second sealing member 42 have different characteristics, respectively. The first sealing member 41 has the resistance against the fuel permeation, while the second sealing member 42 has the resistance against low temperature. Therefore, the sealing part 40 is configured to have contradicting properties.

In the first embodiment, the first sealing member 41 which have the resistance against the fuel permeation is placed at the side of the valve part 22, and the second sealing member 42 which has the resistance against the low temperature is placed at the side of the motor 24. When the first sealing member 41 and the second sealing member 42 are arranged in opposite to those in the above, the evaporated fuel flows into the housing 21 and passes through the sealing member which is placed at the side of the valve part 22 and have a less resistance against the fuel permeation. Thus, the evaporated fuel is to be sealed by the sealing member which is placed at the side of the motor 24. However, in a low temperature condition, the sealing member which is placed at the side of the motor 24 and have less resistance against the low temperature could be hardened. Thus, the evaporated fuel could be released from the housing 21 to the motor 24.

In the present embodiment, the first sealing member 41 which has the resistance against the fuel permeation enables to steadily restrict the leakage of the evaporated fuel. If a small amount of the evaporated fuel permeates the first sealing member 41, and if the temperature becomes lower thereafter, the second sealing member 42 has the resistance against the low temperature and does not become hardened. Therefore, the sealing parts are enabled to store the evaporated fuel therebetween. This configuration enables to restrain the leakage toward the motor 24.

That is, the first sealing member 41 having the resistance against the fuel permeation is placed at the inner side of the housing 21 and closer to the flow of the evaporated fuel. The second sealing member 42 having the resistance against the low temperature is placed at outer side of the first sealing members 41 in the housing 21. This enables the whole of sealing part 40 to enhance its sealing performance.

The first sealing member 41 and the second sealing member 42 are both O-rings and facilitate its implementation at low cost.

### Second Embodiment

A flow rate control valve according to a second embodiment will be described with reference to FIG. 4. The same reference numerals as the first embodiment are given to the same structures in order to eliminate explanation. The flow rate control valve according to the second embodiment is different from that according to the first embodiment only in a configuration of the sealing part.

As shown in FIG. 4, in the flow rate control valve according to the second embodiment, a first sealing member 51 and a second sealing member 52 are both oil seals and included in a sealing part 50. The two sealing members 51 and 52 both have same form while their materials are different. The first sealing member 51 will be described as an example. The first sealing member 51 includes a seal lip 53, a fitting part 54, a connection 55, and a ring spring 56.

The seal rip 53 has a loop form. A cross-section of the seal rip 53 taken along an axial direction does not have a circular shape of such as the O-ring part, but has a substantially triangular shape and protrudes toward the motor shaft 25. The pointed end of the seal lip 53 at the radially inside abuts against the motor shaft 25 and is slidable due to biasing force of the ring spring. A direction in which the motor shaft 25 extends is referred to as “axial direction”. The fitting part 54 has a cylindrical form and abuts against an insertion hole 30. The connection 55 has a loop form and expands inward in a radial direction. The connection 55 connects the end of the sea lip 53 in the axial direction to the end of the fitting part 54 in the axial direction.

The first sealing member 51 has the resistance against the fuel permeation same as the first sealing member 41 in the first embodiment. The second sealing member 52 has the resistance against the low temperature same as the second sealing member 42 in the first embodiment. Therefore, the second embodiment has the same effect as that of the first embodiment. Furthermore, the sealing members 51 and 52 are formed of the oil seals, thereby to enable to enhance the sealing performance.

### Third Embodiment

A flow rate control valve according to a third embodiment will be described with reference to FIG. 5. The same reference numerals as those of the first embodiment are given to the same structures in order to eliminate explanation. The flow rate control valve according to the third embodiment is different from that according to the first embodiment only in a configuration of the sealing part.

As shown in FIG. 5, the flow rate control valve in the third embodiment includes a sealing part 60. The sealing part 60 includes a first sealing member 61 which is the O-ring and a second sealing member 62 which is the oil seal. The form and the material of the first sealing member 61 are same as those of the first sealing member 41 in the first embodiment. The form and the material of the second sealing member 62 are same as those of the second sealing member 52 in the second embodiment. Sealing members 61 and 62 are inserted into an insertion hole 3 of the rotation restriction projected part 35. The insertion hole 3 has a stepped shapes and the steps correspond to the shapes of the sealing members 61 and 62, respectively.

In the third embodiment, the sealing part 60 has different sealing characteristics which include the resistance against the fuel permeation and the resistance against the low temperature. This enables to enhance the sealing performance and to restrict the leakage of the evaporated fuel from the housing 21.

### Fourth Embodiment

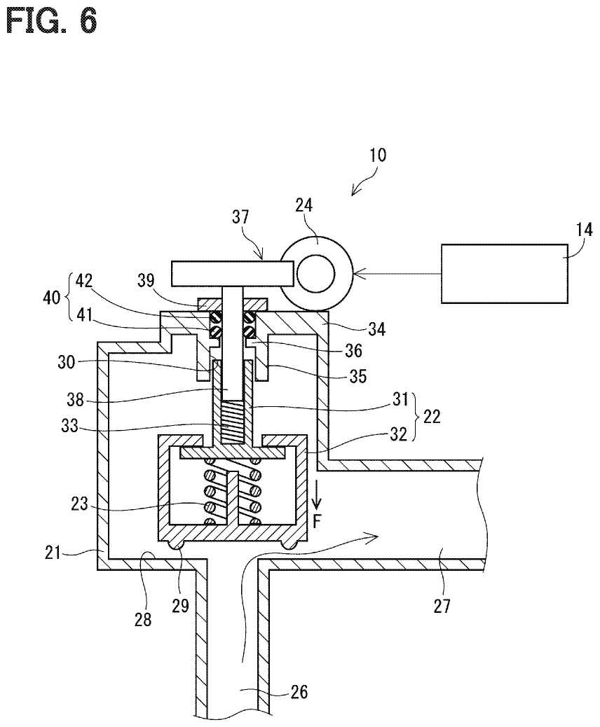

A flow rate control valve according to a fourth embodiment will be described with reference to FIG. 6. The same reference numerals as the first embodiment are given to the same structures in order to eliminate explanation. The flow rate control valve according to the fourth embodiment is different from that according to the first embodiment only in a configuration around the motor.

As shown in FIG. 6, the flow rate control valve 10 in the fourth embodiment includes a worm gear 37 and a shaft 38 that transfer a driving force of the motor 24 to the valve 22. The shaft 38 is connected to the worm gear 37 and penetrates the housing 21. The shaft 38 connects the motor 24 to the valve part 22 so as to enable transmission of a power. The shaft 38 corresponds to a power transmission shaft. A cap 39 is provided to an outside of a part of the bottom wall 34 of the housing 21 at which the shaft 38 penetrates the housing to restrict the sealing members 41 and 42 from coming off.

The configuration of the sealing part 40 is the same as that of the sealing part in the first embodiment. Therefore, the fourth embodiment has same effect as that of the first embodiment. The configuration of the sealing part 50 or 60 in the second or third embodiment may be applied to the configuration to transfer the driving force of the motor 24 through the worm gear 37 in the fourth embodiment.

### Other Embodiment

In the embodiments described in the above, the first sealing members 41, 51, 61 are placed at the side of the valve part 22 and made of the material having the resistance against the fuel permeation. In addition, the second sealing members 42, 52, 62 are placed at the side of the motor 24 and made of the material having the resistance against the low temperature. However, the arrangement of the sealing members may be reversed. It suffices that one sealing member has the resistance against the fuel permeation, and the other sealing member has the resistance against the low temperature. The sealing performance can be enhanced by providing two kinds of sealing members having different characteristics.

In the third embodiment, the first sealing member 61 is formed of the O-ring, and the second sealing member 62 is formed of the oil seal. However, the first sealing member 61 may be formed of the oil seal, and the second sealing member 62 may be formed of the O-ring.

While the present disclosure has been described with reference to preferred embodiments thereof, it is to be understood that the disclosure is not limited to the preferred embodiments and constructions.

What is claimed is:

1. A flow rate control valve for an evaporated fuel treatment device, which includes a fuel tank and a canister to adsorb evaporated fuel generated in the fuel tank, and is to be provided to a vapor passage connecting the canister to the fuel tank, the flow rate control valve comprising:
a housing including a passage to allow the evaporated fuel to flow therethrough from a fuel tank side passage to a canister side passage;
a valve part provided in the housing and configured to shut off the fuel tank side passage from the canister side passage to restrict the evaporated fuel from flowing to the canister side passage and to communicate the fuel tank side passage to the canister side passage to pass the evaporated fuel to the canister side passage;
a driving part placed outside the housing and configured to drive the valve part;
a power transmission shaft penetrating the housing and connecting the driving part to the valve part to transmit power of the driving part to the valve part; and
a sealing part that seals a part through which the power transmission shaft penetrates the housing and restrains a leakage of the evaporated fuel from the housing, wherein
the sealing part includes
a first sealing member; and
a second sealing member, wherein
the first sealing member is made of a first organic material having a resistance against a fuel permeation,
the second sealing member is made of a second organic material having a resistance against low temperature, and
the first organic material is different from the second organic material.

2. The flow rate control valve according to claim 1, wherein
the first sealing member is placed on a side of the valve part, and
the second sealing member is placed on a side of the driving part.

3. The flow rate control valve according to claim 1, wherein
the first sealing member is made of a fluororubber or a perfluoropolyether, and
the second sealing member is made of an acrylonitrile-butadiene rubber, a hydrogenated nitrile rubber or an epichlorohydrin rubber.

4. The flow rate control valve according to claim 1, wherein
the first sealing member and the second sealing member are O-rings, respectively.

5. The flow rate control valve according to claim 1, wherein
the first sealing member and the second sealing member are oil seals, respectively, each including a seal lip, which has a loop form and abutting against the motor shaft slidably, and a fitting part having a cylindrical form and abutting against the housing.

6. The flow rate control valve according to claim 1, wherein
one of the first sealing member and the second sealing member is an O-ring, and the other is an oil seal including a seal lip, which has a loop form and abuts against the motor shaft slidably, and a fitting part having a cylindrical form and abutting against the housing.
